(19) United States
(12) Patent Application Publication
(10) Pub. No.: US 2008/0158441 A1
(43) Pub. Date: Jul. 3, 2008

(54) Image display apparatus and image display method

(75) Inventors: Takahiko Yamamuro, Tokyo (JP); Jun Someya, Tokyo (JP); Shuichi Kagawa, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation

(21) Appl. No.: 11/984,168

(22) Filed: Nov. 14, 2007

(30) Foreign Application Priority Data
Dec. 27, 2006 (JP) 2006-351823

(51) Int. Cl. H04N 5/74

(52) U.S. Cl. 348/759; 348/E05.137

(57) ABSTRACT

An image display apparatus has a light valve that spatially modulates light emitted by a light source according to a gamma-corrected video signal consisting of successive video fields, by modulating the light pulse widths of individual picture elements in each field. The spatially modulated light is projected onto a screen. A light source driver changes the intensity of the light source as a function of elapsed time in each video field so as to approximately cancel the effect of the gamma correction. Only a slight reverse gamma correction is then needed to produce the correct brightness relationship between the video signal and the projected image. Consequently, fewer gradation levels are lost than in a conventional reverse gamma correction, and the picture quality in low-brightness areas of the projected image is improved.

### BACKGROUND OF THE INVENTION

1. Field of the Invention

The present invention relates to an image display apparatus and image display method, more particularly a method of driving a light source to improve the image quality of dark parts of a picture displayed by a video image projector such as a projection television set.

2. Description of the Related Art

Conventional projection television sets use a variety of lamps, typically white light lamps such as xenon arc lamps, metal halide lamps, and halogen lamps, as light sources, and a variety of spatial modulating devices, such as liquid crystal devices and digital micromirror devices (DMDs), as light valves. To achieve longer life and a wider gamut of reproducible colors, some recent projection television sets use light emitting diodes (LEDs) or semiconductor laser diodes (LDs) as light sources. Although there are slight differences in the driving waveforms of lamps, LEDs, and laser diodes, the light sources of these projection television sets are basically driven by constant current, so that the emission intensity or brightness remains constant over time. The constant light is generally modulated by pulse width modulation to express different gradations of brightness of the picture elements (pixels) in the displayed image. (See, for example, Japanese Patent Application Publication No. 10-326080.)

A video display apparatus generally receives a video signal that has been gamma-corrected to compensate for the nonlinear response characteristics of a cathode ray tube (CRT). A projection display apparatus, however, has a linear response: brightness increases in proportion to pulse width, as a linear function of gradation value in the video signal. A projection display apparatus therefore carries out a reverse gamma correction on the received video signal to cancel the gamma correction.

The reverse gamma correction, however, greatly reduces the number of gradations at the low end of the gray scale. A resulting problem is that contour lines tend to appear in dark parts of the displayed picture. This problem has conventionally been attacked from the image-processing angle, by the use of dithering or error diffusion to increase the apparent number of gradations. Dithering and error diffusion significantly improve the image quality in dark picture areas, but have the drawback that speckle noise appears and unsightly periodic patterns may occur, depending on the picture content.

### SUMMARY OF THE INVENTION

An object of the present invention is to mitigate the loss of low-end gradation levels due to reverse gamma correction of video data, and to prevent contour lines from appearing in dark parts of a displayed picture.

The present invention provides an image display apparatus for displaying successive fields of a video signal. In the apparatus, a light source receives driving current and emits light with an intensity that varies according to the magnitude of the driving current. A light source driver supplies the driving current to the light source, changing the magnitude of the driving current as a function of elapsed time within each field. A light valve selectively interrupts the light emitted from the light source so as to modulate individual pixels by pulse width modulation according to a video signal. The modulated light is projected onto a screen.

The video signal has undergone a gamma correction, but by changing the magnitude of the driving current in each field, the present invention brings the relationship between the video signal and brightness in the projected image close to a relationship that cancels the gamma correction. Accordingly, only a slight reverse gamma correction is needed to cancel the gamma correction completely, so that the pulse-width-modulated light valve can produce the correct brightness levels. As a result, few gradation levels are lost in the reverse gamma correction, and the image quality in dark picture areas is greatly improved.

### BRIEF DESCRIPTION OF THE DRAWINGS

In the attached drawings:

FIG. 1 is a block diagram of the image display apparatus in a first embodiment of the present invention;

FIGS. 2(a) to 2(c) are timing diagrams illustrating waveforms of driving current of the colored light emitting devices and a driving signal of the light valve in the first embodiment;

FIG. 3 is a graph showing changes in driving current as a function of elapsed time in an individual field;

FIG. 4 is a graph showing the relationship between the driving current and light emission intensity of the light emitting devices;

FIG. 5 is a graph showing change in light intensity as a function of elapsed time in an individual field;

FIGS. 6(a) to 6(e) illustrate the relationships between video data gradation values and the on-time of the light valve;

FIG. 7 is a graph showing the relationship between the on-time of the light valve and the apparent brightness of a pixel displayed in the first embodiment and the prior art;

FIG. 8 is a table showing the relationships between pre-reverse-gamma-corrected data (Vi) and post-reverse-gamma-corrected data (Zi) in the first embodiment and the prior art;

FIG. 9(a) illustrates driving current pulses supplied to the light source in an individual field in a second embodiment of the invention;

FIG. 9(b) illustrates changes in the width of the driving current pulses in FIG. 9(a) as a function of elapsed time in the field;

FIG. 9(c) illustrates the on-time of the light valve for an exemplary pixel in the field in FIG. 9(a);

FIG. 10(a) shows an enlarged view of part of the pulse train shown in FIG. 9(a);

FIG. 10(b) indicates the light intensity of the light source driven by the pulses in FIG. 10(a);

FIG. 11 shows a pulse train usable as an alternative to the pulse train in FIG. 10(a);

FIGS. 12(a) to 12(d) illustrate driving current pulses supplied to the light source in an individual field, changes in pulse width of the driving current pulses as a function of elapsed time, and on-time of the light valve for exemplary pixels in a third embodiment of the invention; and

FIGS. 13(a) to 13(d) illustrate driving current pulses supplied to the light source in an individual field, changes in pulse width of the driving current pulses as a function of elapsed time, and on-time of the light valve for exemplary pixels in a fourth embodiment of the invention.

### DETAILED DESCRIPTION OF THE INVENTION

Embodiments of the invention will now be described with reference to the attached drawings, in which like elements are indicated by like reference characters.

### First Embodiment

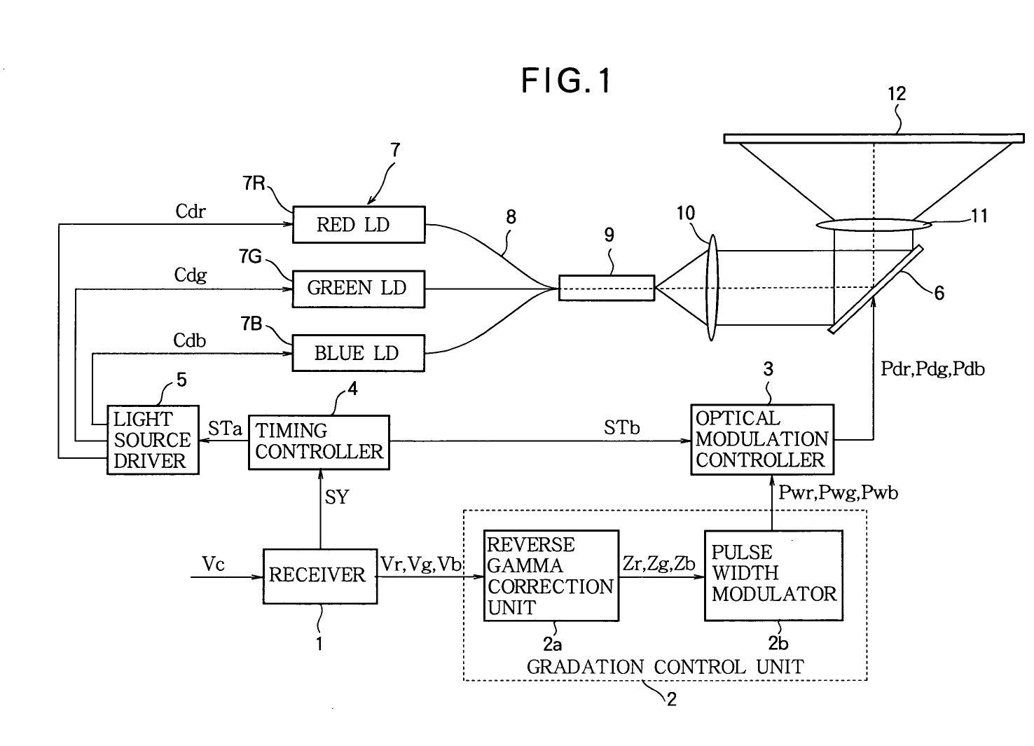

Referring to FIG. 1, the image display apparatus in the first embodiment comprises a receiver 1, a gradation control unit 2, an optical modulation controller 3, a timing controller 4, a light source driver 5, a light valve 6, a light source 7, optical fibers 8, a light pipe 9, and a pair of lenses 10, 11.

Video data (input video data) Vc are input from an external video device (not shown) to the receiver 1. The video data Vc are input to the receiver 1 as, for example, a composite color television signal comprising a synchronizing signal SY, a luminance signal Y, and color difference signals Cr and Cb. The synchronizing signal SY is extracted and sent to the timing controller 4. The luminance signal Y and the color difference signals Cr and Cb are converted to red, green, and blue video data Vr, Vg, Vb and sent to the gradation control unit 2.

The gradation control unit 2 comprises a reverse gamma correction unit 2a and a pulse width modulator 2b. The reverse gamma correction unit 2a carries out a reverse gamma correction on the video data Vr, Vg, Vb of each color supplied from the receiver 1 to generate reverse-gamma-corrected video data Zr, Zg, Zb, also referred to below as video driving data. The pulse width modulator 2b generates corresponding red, green, and blue pulse width modulation data Pwr, Pwg, Pwb. The pulse width modulation data Pwr, Pwg, Pwb are supplied to the optical modulation controller 3. Operating according to the pulse width modulation data Pwr, Pwg, Pwb, the optical modulation controller 3 supplies red, green, and blue driving signals Pdr, Pdg, Pdb to the light valve 6 to control the picture-forming elements in the light valve 6 by switching them individually on and off. The term ‘pixels’ will be used to denote both these picture-forming elements and the dots of light that they project onto the screen 12.

The timing controller 4 generates timing signals STa and STb according to the synchronizing signal SY supplied from the receiver 1, and supplies the timing signals to the optical modulation controller 3 and light source driver 5.

The light source driver 5 supplies driving current Cdr, Cdg, Cdb to the light emitting devices 7R, 7G, 7B in the light source 7. Light emitting diodes (LEDs) or semiconductor laser diodes (LDs) are generally used as the light emitting devices in this type of light source. The embodiments described herein use semiconductor laser diodes.

The red, green, and blue light emitting devices 7R, 7G, 7B are driven in synchronization with on-off control by the corresponding driving signals Pdr, Pdg, Pdr in the light valve 6.

The light emitted from the red, green, and blue light emitting devices 7R, 7G, 7B passes through the optical fibers 8, light pipe 9, lens 10, light valve 6, and lens 11 and reaches the screen 12. The light valve 6 has an array of pixels that individually modulate the light in an on-off manner under control of the driving signals Pdr, Pdg, Pdb. An image corresponding to the video data Zr, Zg, Zb is thereby displayed on the screen 12.

The image display apparatus in this embodiment is a field sequential apparatus that drives the red, green, and blue light emitting devices 7R, 7G, 7B one at a time in successive fields. The light valve 6 is accordingly driven by the red, green, and blue driving signals Pdr, Pdg, Pdb one at a time, in successive fields, in synchronization with the driving of the light emitting devices 7R, 7G, 7B.

Next, the processing of the video data and driving of the light source 7 will be described in more detail.

The video data Vc supplied to the image display device of FIG. 1 are gamma-corrected at the transmitting end to compensate for the nonlinear response of a CRT.

The original signal components Xr, Xg, Xb before the gamma correction and the signal components Vr, Vg, Vb after the gamma correction are related as follows:

Vi=kₐ·Xi^{(1/γa)}

In the above equation:
kₐ is a constant,

### Vi is Vr, Vg, or Vb, and

### Xi is Xr, Xg, or Xb.

Use of this notation will continue in the following description. That is, the letter i will be used instead of r, g, and b when the description is equally applicable to the red, green, and blue signals.

The luminance signal Y, and color difference signals Cr and Cb in the composite video signal Vc received by the receiver 1 have been generated from the gamma-corrected red, green, and blue component signals Vi (that is, from Vr, Vg, and Vb) at the transmitting end. The receiver 1 processes the composite video signal Vc to recover the gamma-corrected red, green, and blue component signals Vi.

The reverse gamma correction unit 2a carries out a reverse gamma correction on the gamma-corrected video data Vi so that the brightness Bi of the image displayed on the screen 12 will be proportionally related to the original video data Xi before the gamma correction; that is, the brightness Br, Bg, Bb of the red, green, and blue pixels will be proportional to the original data values Xr, Xg, Xb.

If, for example, when the gamma correction parameter γa at the transmitting end is 2.2, the reverse gamma correction parameter γb used at the reverse gamma correction unit 2a is:

γb=γa/2=1.1

The reason why the reverse gamma correction parameter γb is equal to γa/2 will be explained later.

The video data Zi after the reverse gamma correction and the video data Vi before reverse gamma correction are related as follows:

Zi=k_{b}·Vi^{γb}

(k_{b} is a constant,

### Zi=Zr, Zg, or Zb, and

### Vi=Vr, Vg, or Vb).

The gradation control unit 2 carries out pulse width modulation according to the gradation values of the reverse-gamma-corrected video data Zi (Zr, Zg, Zb) to generate the pulse width modulation data Pwi (Pwr, Pwg, Pwb), which determine the on-time of each pixel in each field.

The optical modulation controller 3 outputs driving signals Pdi (Pdr, Pdg, Pdb) corresponding to the pulse width modulation data Pwi (Pwr, Pwg, Pwb) at timings controlled by timing signal STb from the timing controller 4 and supplies them to the light valve 6. The driving signals Pdi (Pdr, Pdg, Pdb) correspond to the reverse-gamma-corrected video driving data Zi (Zr, Zg, Zb).

Each pixel in the light valve 6 is switched on or off under control of the driving signals Pdi. In the on-state, light from the light source 7 reaches the screen 12 via the light valve 6; in the off-state, the light from the light source 7 does not pass through the light valve 6 or reach the screen 12.

In pulse width modulation, in each field, a pixel in the light valve 6 is switched on for a duration corresponding to the gradation value of the corresponding video driving data Zi. The on-time is the duration for which the pixel is switched on in the field. The larger the gradation value of video driving data Zi is, the longer the on-time will be, and the brighter the pixel on the screen 12 will appear.

The timing controller 4 sends the timing signals STa and STb to the optical modulation controller 3 and the light source driver 5 according to the synchronizing signal SY supplied from the receiver 1 to synchronize the timing when the optical modulation controller 3 sends a driving signal Pdi (Pdr, Pdg, or Pdb) to the light valve 6 with the timing when the light source driver 5 supplies driving current Cdi (Cdr, Cdg, or Cdb) to the red, green, or blue light emitting device 7i (7R, 7G, or 7B).

The light source driver 5 drives the red, green, and blue light emitting devices 7i (7R, 7G, and 7B) to emit light in successive fields in synchronization with timing signal STa. For example, the light source driver 5 drives the red light emitting device 7R in the first field, the green light emitting device 7G in the second field, the blue light emitting device 7B in the third field, and so on in this sequence.

The light emitted from the red, green, and blue light emitting devices 7R, 7G, 7B reaches the light valve 6 via the optical fibers 8, light pipe 9, and lens 10. The light valve 6 controls the light incident on each pixel by on-off control according to the driving signals Pdr, Pdg, Pdb sent from the optical modulation controller 3. The incident light reaches the screen 12 via lens 11 while the pixel is in the on-state, and does not reach the screen 12 while the pixel is in the off-state. The light is thus spatially modulated to generate image light, which, in turn, is projected on the screen 12 via lens 11 and displayed as a picture.

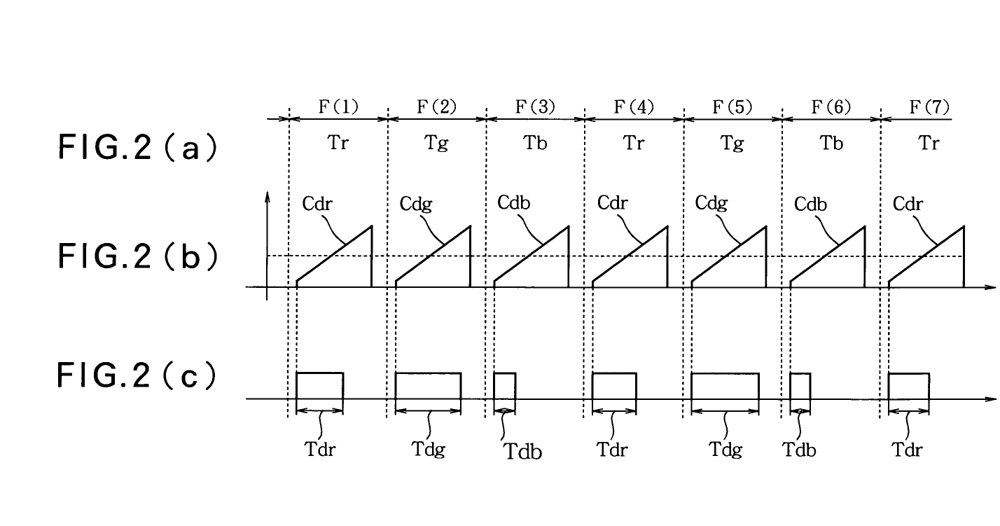

The driving of the red, green, and blue light emitting devices 7R, 7G, 7B in successive fields in synchronization with the driving of the light valve 6 by the red, green, and blue driving signals Pdr, Pdg, Pdb is illustrated in FIGS. 2(a) to 2(c), in which the successive fields are numbered F(1), F(2), F(3), and so on.

Tr, Tg, and Tb respectively indicate the fields in which the red, green, and blue light emitting devices 7R, 7G, 7B are driven, and in which the light valve 6 is driven by the red, green, and blue driving signals Pdr, Pdg, Pdb.

Cdr, Cdg, and Cdb are driving current waveforms. The same waveform is used in each field.

Tdr, Tdg, Tdb are exemplary periods of time (on-time) during which a particular pixel is switched on by the red, green, and blue driving signals Pdr, Pdg, Pdb supplied to the light valve 6. In the illustrated example, the start of the on-time of a pixel in the light valve 6 coincides with the start of the supply of driving current Cdr, Cdg, or Cdb to the light emitting device 7R, 7G, or 7B in the light source 7. The duration of the on-time Tdr, Tdg, or Tdb depends on the value of the video data Zr, Zg, Zb for the particular pixel in the particular field. When the value of the video data Zi (i=r, g, or b) is zero, the light-valve pixel is not switched on, and the duration of its on-time is zero.

As shown by the current driving waveforms Cdr, Cdg, Cdb, the red, green, and blue light emitting devices 7R, 7G, 7B are driven by the light source driver 5 in a time-division mode. In FIGS. 2(a)-2(c), for example, when the red light emitting device 7R is driven in the first field F(1), the green and blue light emitting devices 7G, 7B are switched off; when the green light emitting device is driven in the second field F(2), the red and blue light emitting devices 7R, 7B are switched off; and so on.

Although the optical modulation controller 3 sends the light valve 6 the driving signals Pdi (i=r, g, b) in synchronization with the driving periods of the light emitting devices 7i (i=R, G, B) of the corresponding colors, a pixel in the light valve 6 is usually switched on only for part of the period during which the light emitting device 7i emits light, as can be seen in FIG. 2(c). Although each field of the image is displayed on the screen 12 in only one color (red, green, or blue), the field display period is so short and the colors are switched so rapidly that the image is perceived by the viewer as a natural full-color picture, due to the persistence effect of human vision.

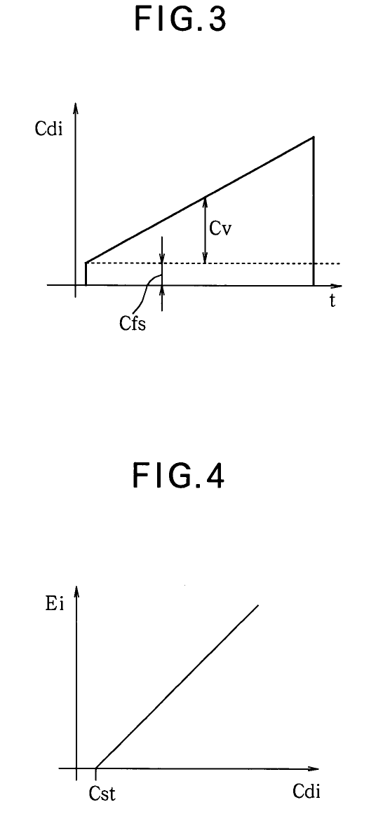

The graph in FIG. 3 shows an exemplary relation between elapsed time t from the start of each field and the driving current Cdi (Cdr, Cdg, or Cdb) supplied to light emitting device 7i (7R, 7G, or 7B). From the start of the driving interval, the driving current Cdi increases linearly as a function of t, with a predefined offset value Cfs as an initial value. In other words, the driving current Cdi comprises a constant offset component Cfs and a component Cv that increases linearly with elapsed time t. The slope or gradient of the driving current Cdi is selected so that the average of the driving current during the driving period does not exceed the maximum average current rating of the light emitting device 7i. The relationship is same for all three colors, as was indicated in FIGS. 2(a) to 2(c).

The graph in FIG. 4 shows the relationship between the driving current Cdi and instantaneous light intensity Ei (emission intensity Er, Eg, or Eb) of the light emitting devices 7R, 7G, 7B of the light source 7. In general, the type of semiconductor laser diode used as a light emitting device 7i emits hardly any light at all at low levels of driving current Cdi. Once Cdi exceeds a certain starting threshold value Cst, however, the emission intensity Ei begins to increase linearly as a function of the driving current Cdi. The offset component Cfs in FIG. 3 is added in consideration of the emission threshold current value Cst. For example, Cfs may be set equal to the threshold current value Cst, as will be assumed in the description below.

The relationship shown in FIG. 4 between the driving current Cdi and the emission intensity of the light emitting device 7i does not have to be the same for all three light emitting devices 7R, 7G, 7B. The light emitting devices 7R, 7G, 7B may have different emission threshold currents, and their intensities may increase with different slopes. To allow for these differences, the driving currents Cdi may have different starting offsets and increase at different rates.

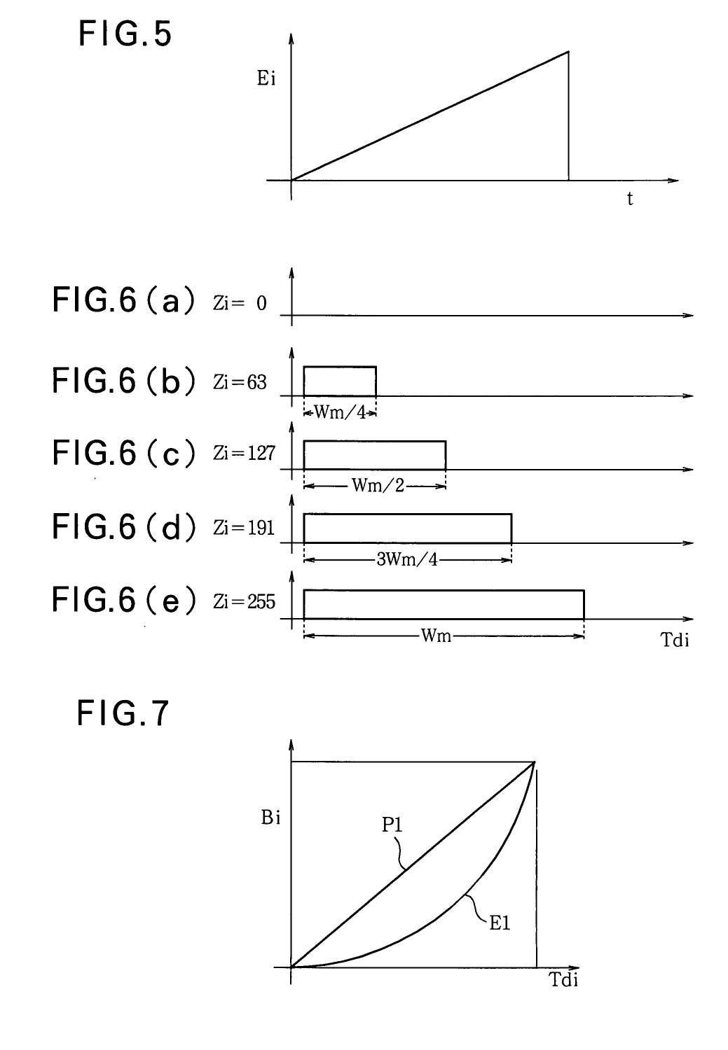

FIG. 5 shows the relationship between the emission intensity Ei of a light emitting device 7i and the elapsed time t from the start of driving. As shown in FIG. 4, the emission intensity Ei increases linearly as a function of driving current Cdi once the current exceeds a threshold value Cst. Thus, as shown in FIG. 3, the driving current Cdi is the sum of an offset component Cfs that is equal to the threshold current value Cst, and a component Cv that increases linearly as a function of the elapsed time t from the start of driving. As a result, the emission intensity Ei of the light emitting device 7i is proportional to the elapsed time from the start of driving.

FIGS. 6(a) to 6(e) illustrate the relationships between the video data gradation value Zi (Zr, Zg, or Zb) according to which a pixel is driven, and the duration of time Tdi (Tdr, Tdg, or Tdb) for which the pixel is switched on (on-time), in a light valve 6 driven by pulse width modulation. When gradation is represented by pulse width modulation, the on-time Tdi of each pixel in the light valve 6 in each field is proportional to the corresponding gradation value Zi of video driving data. In the examples shown in FIGS. 6(a) to 6(e), the video driving data Zi are eight-bit data with a maximum value of 255. The on-time Tdi corresponding to this value (255) is shown as Wm in FIG. 6(e). When the gradation value Zi is 63, the on-time Tdi is Wm/4 as shown in FIG. 6(b); when the gradation value Zi is 127, the on-time Tdi is Wm/2 as shown in FIG. 6(c); when the gradation value Zi is 191, the on-time Tdi is 3Wm/4 as shown in FIG. 6(d). When the gradation value Zi is zero, the on-time Tdi is zero as shown in FIG. 6(a).

The graph in FIG. 7 illustrates the relationship between the on-time Tdi of the light valve 6 and the perceived brightness Bi (brightness of the displayed image) of a pixel displayed on the screen 12 when the light valve 6 is driven by pulse width modulation. The proportional relation shown in FIG. 5 between the instantaneous emission intensity Ei of the light emitting device 7i and the elapsed time t from the start of driving can be expressed as:

Ei=k_{c}·t

(k_{c} is a constant of proportionality). When the light valve 6 is driven by pulse width modulation, the brightness Bi (perceived brightness) of the displayed pixel in each field is proportional to the integral of the emission intensity Ei over the entire field period, that is, the entire on-time Tdi, due to the integrating effect of the retina. Therefore, the brightness can be expressed as:

Bi=k_{d}·∫Eidt=k_{d}·∫k_{c}·tdt=k_{d}·(k_{c}·Tdi²)/2

(k_{d} is a constant). Thus, the brightness Bi of the displayed pixel is proportional to the square of the on-time Tdi, as indicated by the parabolic curve E1 in FIG. 7.

In conventional configurations, the emission intensity Ei is generally constant over the elapsed time t from the start of driving. Therefore, the brightness Bi of the displayed image is directly proportional to the on-time Tdi as shown by the line P1 in FIG. 7.

As described above, in general, the video data input to the image display apparatus have been gamma-corrected with a gamma correction parameter γa to compensate for the nonlinear response of a CRT. The image display apparatus carries out a reverse gamma correction on the input video data in accordance with the output characteristics of the display unit. In this embodiment, since the brightness Bi of the displayed image is proportional to the square of the on-time Tdi, and the on-time Tdi is proportional to video driving data Zi, the brightness Bi of the displayed image is proportional to the square of the video driving data Zi. This relationship can be expressed as:

Bi=kₑ·Zi²

(kₑ is a constant)

Therefore, the relationship between the pre-gamma-correction data Xi (the original video data) and the brightness Bi of the displayed video image can be expressed as:

Bi=k_{f}·((Xi^{1/γa})^{γb})²

(k_{f} is a constant).

In order to establish a proportional relationship between the pre-gamma-correction data Xi (the original video data) and the brightness Bi of the displayed image, the following equation should be satisfied:

(1/γa)·γb·2=1

γb=1/{(1/γa)·2}=γγa/2

When γa is 2.2, the following equation should be satisfied:

γb=γa/2=2.2/2=1.1

These equations explain why the reverse gamma correction parameter γb in the reverse gamma correction unit 2a is set to γa/2=1.1.

If the data Vi and Zi input to and output from the reverse gamma correction unit 2a are normalized so that their maximum values are equal to unity, then when the reverse gamma correction parameter γb is 1.1, the relationship between the normalized value Vn of the input data Vi and the normalized value Zn of the output data Zi can be expressed as:

Zn=Vn^{1.1}

When the input data Vi and output data Zi are eight-bit data, the normalized values are:

Zn=Zi/255

Vn=Vi/255

The following equation can then be derived:

Zi=255×(Vi/255)^{1.1}

In the conventional configuration, the brightness Bi of the displayed image is proportional to the on-time Tdi as shown by line P1 in FIG. 7. The brightness Bi of the displayed image is accordingly proportional to the gradation value of the driving data, and the reverse gamma correction parameter γb must be equal to the gamma correction parameter γa. For example, if the gamma correction parameter γa is 2.2, the reverse gamma correction parameter γb must also be 2.2, and the pre-reverse-gamma-correction data (Vi) and post-reverse-gamma-correction data (Zi) are related as follows:

Zi=255×(Vi/255)^{2.2}

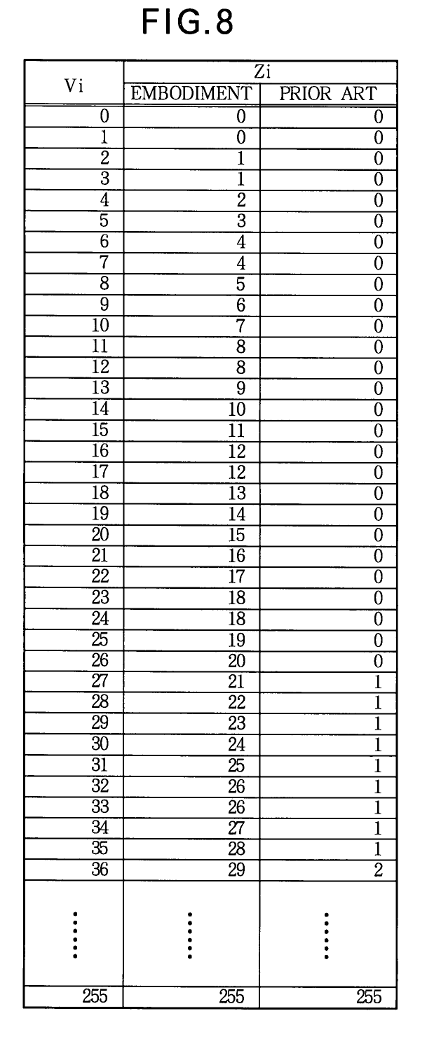

Relationships between pre-reverse-gamma-correction data Vi (input data) and post-reverse-gamma-correction data Zi (output data) are tabulated in FIG. 8. In the prior art, as indicated in the rightmost column, there is much loss of gradation levels in the output data Zi for small input data values at the low end of the gray scale. For example, the output data Zi are ‘0’ for all gradation values of the input data Vi from 0 to 26, and ‘1’ for all gradation values of the input data Vi from 27 to 34. In the present embodiment (middle column), there is much less loss of gradation levels in the output data Zi relative to the input data Vi.

Although FIG. 8 applies specifically to eight-bit video data with a gamma correction parameter of 2.2, the same tendency will be found with different gamma correction parameter values and/or video data with different bit widths.

When the driving current Cd increases linearly as a function of elapsed time t from the start of driving, the relationship between the gradation value Zi of the video driving data and brightness Bi of the displayed image has a curve that can substantially cancel the gamma correction. Thus, the loss of low gradation levels can be reduced when reverse gamma correction is carried out to generate video driving data Zi.

In the above example, the driving current Cdi comprises an offset component Cfs and a component Cv that increases linearly as a function of the elapsed time t from the start of driving, but the offset component Cfs may be omitted. The driving current Cdi may be set to start from zero and increase linearly. In this case, however, the emission intensity Ei of the light emitting device 7i is substantially zero during an initial interval after driving begins. In order to use the field time efficiently, it is preferable for the driving current Cdi to include an offset component Cfs.

In the above example, the emission intensity Ei increases linearly as a function of the driving current Cdi as shown in FIG. 4, and the driving current Cd increases linearly as a function of the elapsed time t from the start of driving. However, the relationship between the elapsed time t from the start of driving and the driving current Cdi can be modified depending on the relation of emission intensity Ei to the driving current Cdi, and the values of the gamma correction parameter γa and reverse gamma correction parameter γb.

Furthermore, although semiconductor laser diodes (LDs) are used as the light emitting devices in the above example, the same effect is obtained if light emitting diodes (LEDs) are used.

As described, in this embodiment, changing the current Cdi flowing through the light emitting devices 7i and thereby changing the emission intensity Ei as a function of elapsed time t from the start of driving can produce a relationship between the on-time Tdi of a pixel and the brightness Bi of the displayed image that closely approximates the correction curve needed for compensating for the gamma correction when a light valve is driven by pulse width modulation. The reverse gamma correction parameter γb for generating the video driving data Zi can have a reduced value, so that there is much less loss of gradation levels in the reverse-gamma-corrected output data at the low end of the gray scale. As a result, dark pictures show smoothly changing gradations, which significantly improves image quality at the low end of the gray scale.

The semiconductor light source 7 used in the first embodiment has the advantage of responding rapidly to current changes, but in principle the invention can be practiced with any type of current-driven light source having a controllable emission intensity.

Although the first embodiment has been described as color image display apparatus, the invention can also be practiced in monochrome image display apparatus, with the same effect.

### Second Embodiment

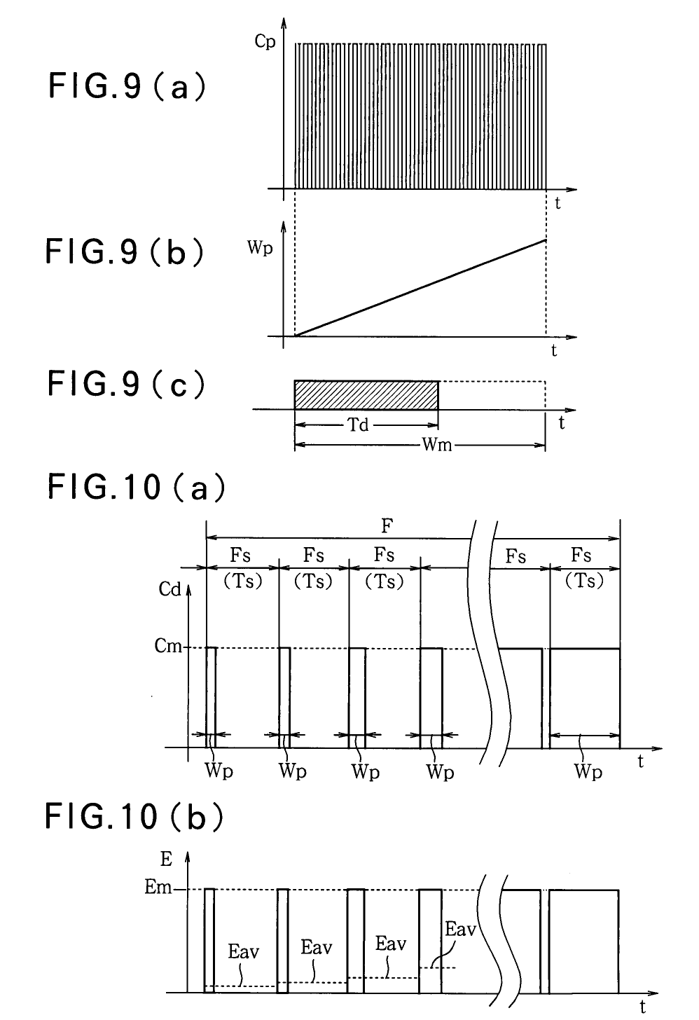

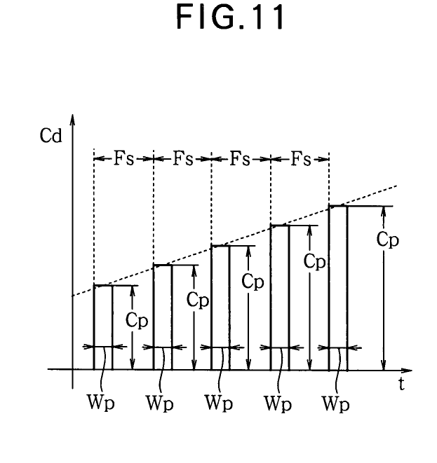

In the first embodiment, driving current Cd flows continuously from the start to the end of driving period in each field. In the second embodiment, the driving current is pulsed as shown in FIGS. 9(a) to 9(c) and FIGS. 10(a) and 10(b), with a predetermined pulse period Ts and an increasing pulse width Wp. FIG. 9(a) illustrates the pulse train in one field. FIG. 9(b) illustrates changes in the pulse width Wp in the field F. FIG. 9(c) illustrates the on-time Td of an exemplary pixel in the light valve. FIGS. 10(a) and 10(b) show enlarged partial views of the current pulse train in FIG. 9(a) and the corresponding light pulse train.

As best seen in FIG. 10(a), the field F is divided into a plurality of subfields Fs of equal length Ts. One current pulse is generated per subfield. The pulse height Cm is identical for all pulses, but the pulse width Wp increases with elapsed time t so that a pulse generated later in the field F has a greater width. For example, the pulse width Wp may increase as a linear function of the elapsed time t measured from the start of the pulse train, as shown in FIG. 9(b). In the example shown in FIG. 10(a), the pulse width Wp in the last subfield Fs of the field F is equal to the subfield duration Ts.

The image display apparatus in the second embodiment has the same structure as in the first embodiment, shown in FIG. 1, but differs in regard to the operation of the light source driver 5 which, in the second embodiment, drives the light source 7 with pulsed driving current Cd as shown in FIG. 10(a).

In the second embodiment, as in the first embodiment, each of the three light emitting devices 7i (i=R, G, or B) in the light source 7 is driven by separate driving current Cdi, and different light emitting devices are driven in successive fields, but for simplicity, the description below will refer to a pulsed driving current Cd with amplitude Cp and pulse width Wp as driving the light source 7, without adding the letter i to denote an individual primary color.

When the driving current is pulsed as shown in FIG. 10(a), the instantaneous emission intensity E of the light source 7 changes as indicated by the solid line in FIG. 10(b).

When the pulses of emitted light are modulated by the light valve 6 to display an image, brightness B in the displayed image is proportional to the time-integral of the emission intensity E over the entire field F. The instantaneous emission intensity Em produced by a current pulse of amplitude Cm can be expressed as follows:

Em=k_{g}·(Cm−Cfs)

(k_{g} is a constant)

The integral of the emission intensity Em over the subfield period can be expressed as:

Em×Wp=k_{g}·(Cm−Cfs)×Wp

Since Cm is constant and Wp increases in proportion to the elapsed time t from the start of driving, the integral of the emission intensity E over a subfield increases in proportion to the elapsed time t. The integral of the emission intensity E over a subfield Fs is proportional to the average emission intensity Eav in the subfield, which is indicated by a dotted line in FIG. 10(b).

The second embodiment therefore produces the same effect as the first embodiment, in which the driving current Cd flows continuously and the intensity of the current increases with elapsed time t. More specifically, the linear increase in the pulse width Wp per subfield Fs as a function of elapsed time t from the start of driving in the field F makes the brightness B of a pixel in the displayed image proportional to the square of the on-time Td, as in the first embodiment.

As an alternative to the type of pulse train shown in FIG. 10(a), the driving current Cd can be pulsed as shown in FIG. 11. In FIG. 11, a field F is divided into a plurality of subfields Fs of equal length, and one pulse is generated per subfield Fs as in FIG. 10(a), but the pulse width Wp remains constant, and the pulse height Cp increases with elapsed time t from the start of the pulse train in the field F. In other words, pulses generated later in the field F have a greater amplitude Cp. The pulse height Cp may increase linearly as indicated by the dotted line in FIG. 11.

In this case, the difference between the pulse height Cp generated in a subfield and the offset value Cfs should be proportional to the elapsed time t from the start of the pulse train, in order to make the brightness B of the displayed image proportional to the square of the on-time Td.

As a further alternative, both the pulse width and the pulse height can change during the pulse train. For example, the pulse height may change in one part of a field, and the pulse width may change in another part of the field, as in the third and fourth embodiments described below.

### Third Embodiment

When both the width and height of the pulses in the pulse train change during the field, since the integrated emission intensity of the light source over a subfield is proportional to the product of the pulse width and the difference between the pulse height and the offset value Cfs, if this product is proportional to the elapsed time t from the start of the pulse train in a field F, the brightness B of a pixel in the displayed image will be proportional to the square of its on-time Td.

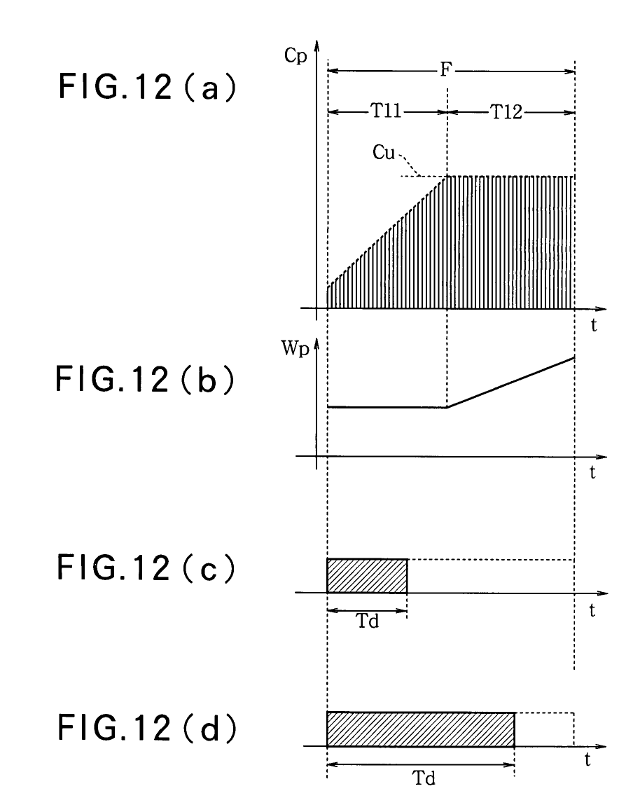

The light-source driving scheme in the third embodiment will be described is illustrated in FIGS. 12(a) to 12(d). As in the second embodiment, the driving current is pulsed and the pulse train has a predefined constant period; that is, the field is divided into subfields Fs of equal length and there is one pulse per subfield.

In the third embodiment, during a first part of a field F (for example, the first half-field T11), the pulse width Wp of the driving current remains constant and the pulse height (magnitude of the driving current) Cp changes as a function of elapsed time t from the start of the pulse train. Then during a second part of the field F (for example, the second half-field T12), the pulse height Cp remains constant and the pulse width Wp changes. In the example shown in FIGS. 12(a) to 12(d), during the first interval T11, the pulse height Cp increases linearly with elapsed time t, while the pulse width Wp remains constant. The pulse height at the end of the first period T11 is denoted Cu. During the second period T12, the pulse height Cp remains constant at Cu while the pulse width Wp increases linearly with elapsed time t.

Throughout the first part T11 and the second part T12 of the field, the product of the pulse width Wp and the difference between the pulse height Cp and offset Cfs (indicated in FIG. 3) is proportional to the elapsed time t from the start of driving in the field F.

The on-time Td of a light valve pixel may end in the first part T11 of the field F as shown by waveform in FIG. 12(c), or in the second part T12 as shown by waveform in FIG. 12(d).

If the light source is driven in this way, the integral of the emission intensity E over each subfield Fs increases in proportion to the elapsed time t from the start of driving in the field F. Therefore, the brightness B of a pixel in the displayed image is proportional to the square of its on-time Td, producing the same effect as in the first and second embodiments.

### Fourth Embodiment

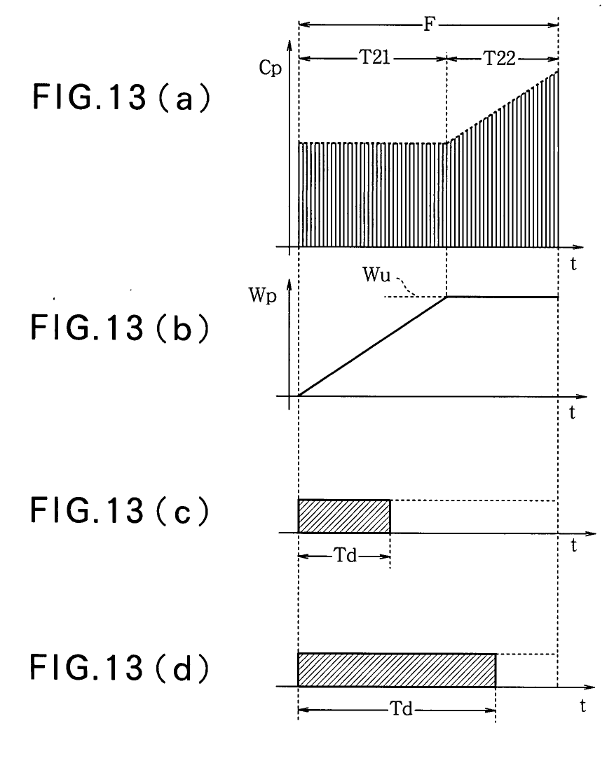

Referring to FIGS. 13(a) to 13(d), in the fourth embodiment, in a first part of the field F (for example, the first half-field T21), the pulse height (magnitude) Cp of the driving current remains constant and the pulse width Wp changes as a function of elapsed time t from the start of driving, while in a second part of the field F (for example, the second half-field T22), the pulse width Wp remains constant and the pulse height Cp changes, as shown by the pulse height (a) and width (b) waveforms. In the first part T21 of the field, the pulse width Wp increases linearly with elapsed time t from the start of the pulse train, while the pulse height Cp remains constant. The pulse width at the end of the first part T21 is denoted Wu. During the second part T22 of the field, the pulse width Wp remains constant at Wu while the pulse height Cp increases linearly with elapsed time t.

The pulse width Wu at the end of the first interval T21 may be equal to the length of subfield Fs, so that in the second interval T22, the duty cycle is 100% and the falling edge of the pulse in one subfield coincides with the rising edge of the pulse in the next subfield. In this case, in the second interval T22 the pulses merge into a continuous current flow.

Throughout the first part T21 and second part T22 of the field, the product of the difference between the pulse height Cp and offset Cfs and the pulse width Wp is proportional to the elapsed time t from the start of the pulse train in the field F.

The on-time Td of a light valve pixel may end in the first part T21 of the frame as shown by waveform in FIG. 13(c), or it may end in the second part T22 as shown by waveform FIG. 13(d).

If the light source is driven in this way, the integral of the emission intensity E over each subfield Fs increases in proportion to the elapsed time t from the start of the pulse train in the field F. Therefore, the brightness B of a pixel in the displayed image is proportional to the square of its on-time Td, producing the same effect as in the first or second embodiment.

The image display apparatus in the third and fourth embodiments has the same structure as in the first embodiment, shown in FIG. 1, differing only in the operation of the light source driver 5. In the third embodiment, the light source driver 5 drives the light source with current pulsed as shown by waveforms in FIGS. 12(a) and 12(b); in the fourth embodiment, the light source driver 5 drives the light source with a current pulsed as shown by waveforms in FIGS. 13(a) and 13(b).

The second through fourth embodiments represent three possible variations of the first embodiment, but those skilled in the art will recognize that further variations are also possible within the scope of the invention, which is defined in the appended claims.

What is claimed is:

1. An image display apparatus for displaying successive fields of a video signal, comprising:
a light source for receiving driving current and emitting light with an intensity that varies according to a magnitude of the driving current;
a light source driver for driving the light source by using the driving current; and
a light valve having a plurality of picture-forming elements (pixels) driven individually by pulse width modulation according to a video signal to modulate the light emitted from the light source and project the modulated light onto a screen; wherein
the light source driver changes the magnitude of the driving current of the light source as a function of elapsed time in each field.

2. The image display apparatus of claim 1, wherein:
in each field, each pixel in the light valve is turned on for a time duration responsive to a gradation value derived from the video signal; and
the light source driver increases the magnitude of the driving current of the light source as a linear function of elapsed time while the light valve modulates the light emitted from the light source.

3. The image display apparatus of claim 2, wherein in each field, the driving current includes a constant offset component equal to a minimum current at which the light source emits light, and a time-varying component increasing as a proportional function of the elapsed time.

4. An image display apparatus for displaying successive fields of a video signal, comprising:
a light source for receiving driving current and emitting light with an intensity that varies according to a magnitude of the driving current;
a light source driver for driving the light source by using the driving current; and
a light valve having a plurality of pixels driven individually by pulse width modulation according to a video signal to modulate the light emitted from the light source and project the modulated light onto a screen; wherein
in each field, the light source driver applies driving current pulses to the light source at constant intervals shorter than a length of the field, each driving current pulse having a width and a height, and changes a product of the width and the height as a function of elapsed time in the field.

5. The image display apparatus of claim 4, wherein the driving current pulses have a constant height and varying widths.

6. The image display apparatus of claim 4, wherein the driving current pulses have a constant width and varying heights.

7. The image display apparatus of claim 4, wherein:
in each field, each pixel in the light valve is turned on for a time duration responsive to a gradation value derived from the video signal; and
the light source driver increases the product of the height and width of the driving current pulse as a linear function of elapsed time while the light valve modulates the light emitted from the light source.

8. The image display apparatus of claim 7, wherein in each field, the driving current includes a constant offset component equal to a minimum current at which the light source emits light.

9. The image display apparatus of claim 4, wherein:
the driving current pulses have constant width and varying height in one part of each field, and have constant height and varying width in another part of the field.

10. The image display apparatus of claim 9, wherein:
in said one part of the field, the height of the driving current pulses increases as a linear function of the elapsed time in the field; and
in said another part of the field, the width of the driving current pulses increases as a linear function of the elapsed time in the field.

11. The image display apparatus of claim 1, wherein:
the light source includes a plurality of light emitting devices emitting light of different colors; and
the light source driver causes the plurality of light emitting devices to emit light in turn in different fields.

12. The image display apparatus of claim 4, wherein:
the light source includes a plurality of light emitting devices emitting light of different colors; and
the light source driver causes the plurality of light emitting devices to emit light in turn in different fields.

13. A method of using an image display apparatus having a light source and a light valve including a plurality of pixels to display successive fields of a video signal, the method comprising:
driving the light source with driving current that varies as a function of elapsed time in each field;
driving the pixels in the light valve individually by pulse width modulation according to the video signal to modulate the light emitted from the light source; and
projecting the light modulated in the light valve onto a screen.

14. A method of using an image display apparatus having a light source and a light valve including a plurality of pixels to display successive fields of a video signal, the method comprising:
driving the light source in each field with driving current pulses supplied at constant intervals shorter than a length of the field, each driving current pulse having a width and a height, a product of the width and the height changing as a function of elapsed time in the field;
driving the pixels in the light valve individually by pulse width modulation according to the video signal to modulate the light emitted from the light source; and
projecting the light modulated in the light valve onto a screen.
